(19) United States
(12) Patent Application Publication
(10) Pub. No.: US 2016/0053843 A1
(43) Pub. Date: Feb. 25, 2016

(54) DEVICE FOR ABSORBING IMPACT

(71) Applicant: UNIVERSITY OF FLORIDA RESEARCH FOUNDATION, INC., Gainesville, FL (US)

(72) Inventors: Ghatu Subhash, Gainesville, FL (US); Keith R. Peters, Gainesville, FL (US)

(21) Appl. No.: 14/778,747

(22) PCT Filed: Mar. 21, 2014
(86) PCT No.: PCT/US2014/031450

§ 371 Date: Sep. 21, 2015

Related U.S. Application Data
(60) Provisional application No. 61/861,723, filed on Aug. 2, 2013.
(60) Provisional application No. 61/804,032, filed on Mar. 21, 2013.

(51) Int. Cl. F16F 13/08; A42B 3/12

(52) U.S. Cl. CPC F16F 13/08; A42B 3/121

(57) ABSTRACT

Disclosed herein is an energy absorbing article comprising a first energy absorbing device and a second energy absorbing device, where the first energy absorbing device and the second energy absorbing device each comprise a first chamber; where the first chamber has a predetermined shape and contains a fluid that can be expelled upon the first chamber being subjected to an impact; and a second chamber in fluid communication with the first chamber; the second chamber being operative to receive the fluid that is expelled from the first chamber and to return the fluid to the first chamber as a result of pressure generated by its own elasticity and without the assistance of any other external manmade force.

### CROSS REFERENCE TO RELATED APPLICATIONS

This application claims the benefit of International Application No. PCT/US14/031450 filed on Mar. 21, 2014 which claims the benefit of U.S. Application No. 61/804032, filed on Mar. 21, 2013, and U.S. Application No. 61/861723, filed on Aug. 2, 2013, each of which are incorporated herein by reference in their entirety.

### BACKGROUND

This disclosure relates to an energy-absorbing device, methods of manufacture thereof and articles comprising the same. In particular, this disclosure relates to reusable energy-absorbing devices.

Energy-absorbing devices are generally used as protective devices to minimize or reduce damage to life and limb during high energy impact. Energy absorbing devices are also used to minimize impact to vehicles and machine parts.

Energy absorbing devices that are designed to absorb impact generally get destroyed when subjected to high energy impacts. An example of this is an automobile bumper. Automobile bumpers are manufactured from polymers and can survive an impact at under 5 miles per hour (by another automobile of a comparative size travelling at approximately the same speed) at room temperature with minimal deformation. However, when subjected to impacts at greater than 5 miles per hour, they undergo permanent deformation and have to be replaced. In addition, when the ambient temperature decreases to below room temperature, especially below 0° C., they often fail catastrophically even at impacts at lower than 5 miles per hour.

It is therefore desirable to provide impact absorption devices that can absorb much higher impacts at a range of temperatures without undergoing catastrophic deformation. In short, it is desirable to manufacture less expensive energy absorption devices that are reusable.

### SUMMARY

Disclosed herein is an energy absorbing device comprising a first chamber; where the first chamber has a predetermined shape and contains a fluid that can be expelled upon the first chamber being subjected to an impact; and a second chamber in fluid communication with the first chamber; the second chamber being operative to receive the fluid that is expelled from the first chamber and to return the fluid to the first chamber as a result of pressure generated by its own elasticity and without the assistance of any other external force.

Disclosed herein too is a method comprising subjecting an energy absorbing device to an impact, where the impact is sufficient to deform a first chamber and where the energy absorbing device comprises the first chamber; where the first chamber has a predetermined shape and contains a fluid that can be expelled upon the first chamber being subjected to the impact; and a second chamber in fluid communication with the first chamber; the second chamber being operative to receive the fluid that is expelled from the first chamber and to return the fluid to the first chamber as a result of pressure generated by its own elasticity and without the assistance of any other external force.

Disclosed herein too is a method comprising molding a first chamber; molding a second chamber; manufacturing a choke point; and assembling the first chamber, the second chamber and the choke point in a manner such that the first chamber and the second chamber are disposed on opposing sides of the choke point.

Disclosed herein too is an energy absorbing article comprising a first energy absorbing device and a second energy absorbing device, where the first energy absorbing device and the second energy absorbing device each comprise a first chamber; where the first chamber has a predetermined shape and contains a fluid that can be expelled upon the first chamber being subjected to an impact; and a second chamber in fluid communication with the first chamber; the second chamber being operative to receive the fluid that is expelled from the first chamber and to return the fluid to the first chamber as a result of pressure generated by its own elasticity and without the assistance of any other external manmade force; and where the first energy absorbing device is opposedly disposed to the second energy absorbing device such that the first chamber of the first energy absorbing device lies adjacent to the second chamber of the second energy absorbing device, and where the second chamber of the first energy absorbing device lies adjacent to the first chamber of the second energy absorbing device.

### BRIEF DESCRIPTION OF THE FIGURES

FIG. 1 is a depiction of an exemplary energy-absorbing device;

FIG. 2 is a schematic depiction of the functioning of the exemplary energy-absorbing device; FIG. 2(A) depicts the energy absorbing device prior to being impacted. FIG. 2(B) depicts the device 100 immediately after impact. FIG. 2(C) depicts the device after it has recovered from the impact; and

FIGS. 3(A)-3(D) depict examples of the use of the energy absorbing device (from the FIGS. 1 and 2) in an article-namely a crash helmet. FIG. 3(A) depicts the helmet. FIG. 3(B) depicts a strip that contains the energy absorbing device. FIG. 3(C) depicts a strip that contains pouches that contain a fluid and FIG. 3(D) depicts energy absorbing devices that are disposed in opposing configurations next to each other;

FIG. 4 is a depiction of another exemplary configuration for absorbing impact.

FIG. 5 is a depiction of the experimental set-up that is used for testing the energy absorbing device; and

FIG. 6 is a graph that depicts impact intensity versus time of dissipation for an impact provided by a force of 500 grams.

### DETAILED DESCRIPTION

Disclosed herein is an energy absorption device that comprises a first chamber filled with a Newtonian fluid that is in fluid communication with a second chamber. The first chamber has a preformed shape and comprises the Newtonian fluid that is displaced into the second chamber, when the first chamber is subjected to an impact. The second chamber is initially in a collapsed state at rest (similar to a deflated balloon) and accepts the Newtonian fluid that is forcefully expelled from the first chamber due to the impact. The second chamber expands as a result of the fluid that is expelled from the first chamber into it. The second chamber then returns to its original state without any man-made force (other than that provided for by the elasticity of the second chamber and the vacuum created in the first chamber) and forces the fluid that is expelled from the first chamber back into the first chamber. The ability of the first chamber to expel its fluid into the second chamber enables the device to absorb a high energy impact. In addition, the ability of the second chamber to force the fluid back into the first chamber enables the device to be restored to its original shape and to therefore be reused.

Impact absorption devices (e.g., helmets, and the like) that comprise the energy absorption device can therefore be reused without any reduction in absorption capabilities. The energy absorption device can be integrated into a new helmet design, or alternatively can be retrofitted into an existing helmet with the modification of the existing foam and strap cushion systems, or as an additional element worn by the athlete under the helmet, much like a swimmer's cap.

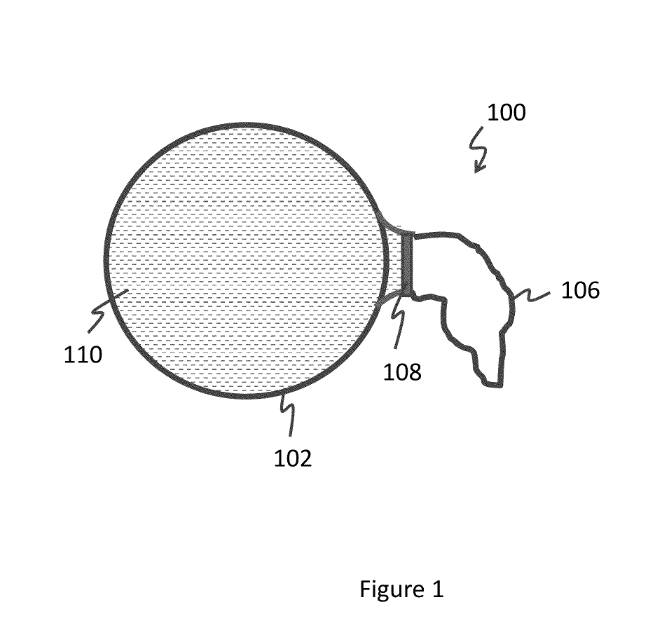

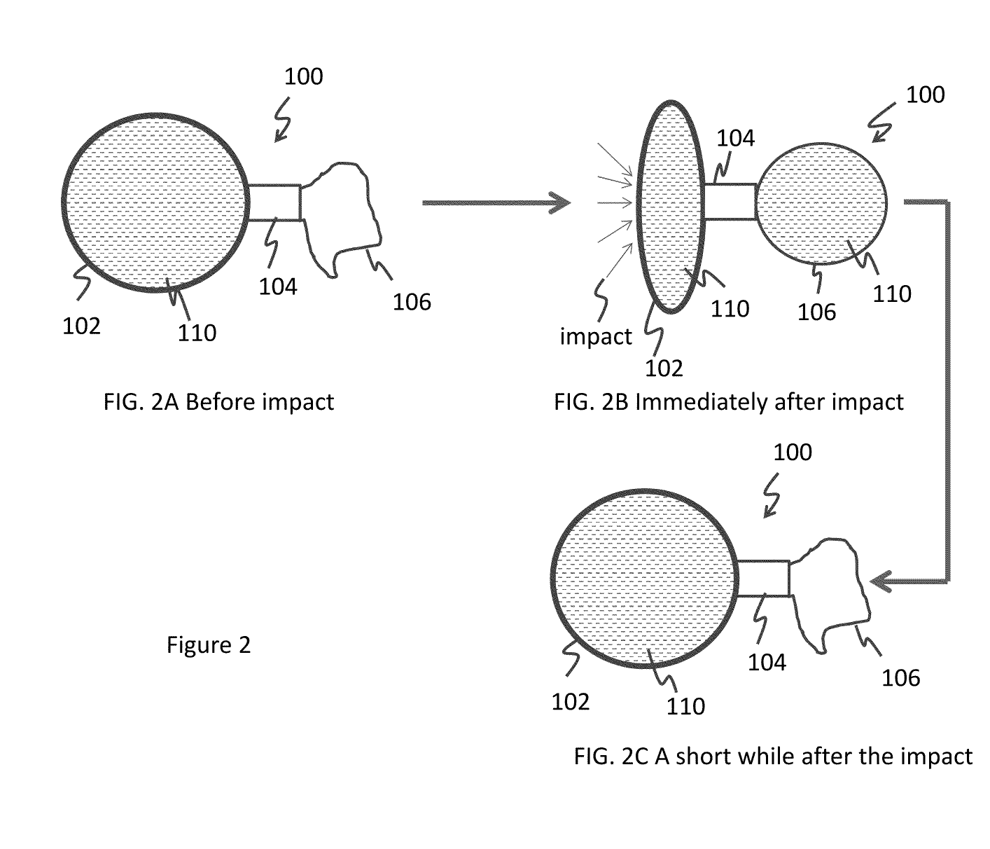

With reference to the FIG. 1, the energy absorption device 100 comprises a first chamber 102 that is in fluid communication with a second chamber 106. The first chamber 102 contains a fluid 110 which is expelled into the second chamber 106 upon subjecting the energy absorption device 100 to an impact. In an exemplary embodiment, the first chamber 102 is in direct fluid communication with the second chamber 106. In another embodiment (depicted in the FIGS. 2(A)-2(C), the first chamber 102 is in direct fluid communication with the second chamber 106 through an optional choke point 104. The choke point 104 functions to permit the fluid to travel from the first chamber 102 to the second chamber 106 and vice versa only when the ambient pressure on the upstream side of the choke point 104 exceeds a predetermined threshold pressure. In short, the choke point 104 serves to prevent fluid from flowing from the first chamber 102 to the second chamber 106 under the influence of gravity or under atmospheric pressure (due to changes in ambient temperature). It is to be noted that while the FIGS. 1 and 2(A)-2(C), there is only a single flow passage between the first chamber 102 and the second chamber 106, there can be multiple passages between the two and each of these passages can have a choke point 104. In addition, a single passage can be fitted with multiple choke points.

The FIGS. 2(A)-2(C) depict in sequence the functioning of the energy absorbing device. FIG. 2(A) depicts the energy absorbing device 100 prior to being impacted, while FIG. 2(B) depicts the device 100 immediately after impact. FIG. 2(C) depicts the device after it has recovered from the impact.

As can be seen in the FIG. 2(A), the first chamber 102 has pre-formed (i.e., a predetermined) shape and has a volume sufficient to dissipate energy for a given impact rating. The volume and shape of the first chamber 102 can be changed depending upon the magnitude of the impact that the device is designed to absorb. The first chamber 102 is disposed on an opposing side of the optional choke point 104 as the second chamber 104. The first chamber 102 contains a fluid that can be discharged from the first chamber 102 through the choke point 104 to the second chamber 106. In an embodiment, at least one of the first chamber 102 or the second chamber 106 may contain a foam that can absorb the fluid that travels between the first and the second chambers. The foam can absorb the fluid and can expel the fluid when subject to a compressive force that deforms the chamber that contains the foam. In an embodiment, either the first chamber 102, the second chamber 106 or both the first and the second chamber may contain the foam.

The foam can be a closed cell foam or an open cell foam. The foam is preferably an elastomeric foam and is capable of absorbing the fluid when expanding and expelling the fluid when being compressed. In an embodiment, the foam expands upon absorbing the fluid. The foam generally has a porosity of 50 to 99 volume percent, preferably 75 to 95 volume percent and more preferably 85 to 93 volume percent.

Exemplary foams are polymeric foams. Elastomeric foams are preferred. Examples of suitable polymeric foams are polyurethane foams, cellulose foams, polyolefin foams, polysiloxane foams, elastomeric block copolymer foams (e.g., styrene-butadiene block copolymer foams, acrylonitrile-butadiene-styrene block copolymer foams), and the like.

The first chamber 102 and the second chamber 106 are both manufactured from a polymeric material. The polymeric material is preferably in an elastic state during operation of the device. In an exemplary embodiment, the first chamber 102 and the second chamber 106 both comprise an elastomer. These elastomers can be chemically crosslinked or physically crosslinked (i.e. they can be block copolymers). In one embodiment, the polymeric material or elastomer used in the first chamber 102 and the second chamber 106 may be the same as each other (i.e., they have the same chemical composition). When the polymeric material or elastomer used in the first chamber 102 and the second chamber 106 are identical with each other, the wall thickness w₁ of the first chamber 102 is generally greater than the wall thickness w₂ of the second chamber. In another embodiment, the polymeric material or elastomer used in the first chamber 102 and the second chamber 106 may be different from each other. When the polymeric material or elastomer used in the first chamber 102 and the second chamber 106 are different from each other, it is generally desirable for the material used in the second chamber 106 to have a higher modulus of elasticity than the material used in the first chamber 102. This is because the second chamber 106 forces the fluid that is expelled into it back into the first chamber 102 by virtue of its elasticity.

The initial volume of the first chamber 102 is 2 or more times greater, specifically 5 or more times greater, specifically 10 or more times greater, and specifically 50 or more times greater than the initial volume of the second chamber 106.

As noted above, the first chamber 102 is manufactured into a predetermined shape. The predetermined shape has a geometrical configuration to which the first chamber will return to upon the removal of a deforming force. Since the first chamber 102 is manufactured from an elastomer or a polymer (that is in its elastic state at the time of operation of the device), it can be deformed and returned to its original predetermined shape after deformation without the use of any external restoring force. The only restoring force for the polymeric material of first chamber 102 is the entropy and optionally the enthalpy of the polymeric chains.

The predetermined shape is preferably a regular geometrical shape, i.e., it can have a cross-sectional geometry that is circular, square, rectangular, triangular, polygonal, ellipsoidal, or the like, or a combination comprising at least one of the foregoing geometries. When the first chamber 102 is in its initial predetermined shape, it is in its lowest energy state. When deformed as the result of an impact as shown in the FIG. 2(B), the first chamber 102 is in a higher energy state (which is a thermodynamically unfavorable state) and therefore desires to return to its lowest energy state which is the initial predetermined shape.

An example of an object that behaves in a similar manner to the first chamber 102 is the bulb of a baster (not shown) that is used to baste meats (e.g., turkey) as they are baked in an oven. The bulb is deformed by the user to release a marinade on to the meat, but returns to its original shape, when the deforming force is removed.

The second chamber 106 is also manufactured from a polymeric material and/or an elastomer. The second chamber 106 has no predetermined shape, but is at its lowest energy state when it is undeformed and is at a higher energy state when it is deformed by the expelled fluid from the first chamber 102. The second chamber 106 in its initial state has a significantly lower volume than the first chamber 102. The volume of the second chamber 106 increases uniformly to accommodate the fluid that is expelled from the first chamber 102. In a similar manner, the volume of the second chamber 106 decreases uniformly as it discharges the expelled fluid back to the first chamber 102. The second chamber 106 is therefore a variable volume vessel that can accommodate the entire volume of fluid that is expelled from the first chamber 102 and can discharge almost all of it back to the first chamber 102. An example of the second chamber is a standard commercially available balloon manufactured from an elastomer—one that expands upon blowing air into it and releases the air upon removal of any man-made constraints.

It is to be noted that the second chamber 106 forces the fluid into the first chamber 102 without the use of any external man-made force. The only forces acting on the second chamber 106 are its elasticity, ambient atmospheric pressure and the vacuum created in the first chamber 102 by the displacement of fluid to the second chamber 106.

The first chamber 102 and the second chamber 106 can be in direct communication with one another. For example, the second chamber 106 can be directly molded onto the first chamber 102. In another embodiment, the second chamber 106 can be clamped (by a clamp 108 as seen in the FIG. 1) or adhesively bonded to the first chamber 102. When the first chamber 102 and the second chamber 106 are in communication with one another via the choke 104, they can both be individually clamped onto the choke or alternatively directly molded on it.

The choke point 104 has a minimum pressure which has to be overcome in order for the fluid to flow across it. Thus the energy of the impact has to produce a pressure in the fluid that exceeds the pressure rating in the choke point 104 in order for the fluid to flow from one chamber to another across the choke point. In one embodiment, the optional choke point 104 can be a choke valve. A choke valve is a type of valve designed to create choked flow in a fluid. Over a wide range of valve settings the flow through the valve can be understood by ignoring the viscosity of the fluid passing through the valve; the rate of flow is determined only by the ambient pressure on the upstream side of the valve. The choke valve prevents the unnecessary motion of fluid between the chambers. It is to be noted that the pressure exerted by the elastic forces in the second chamber 106 are always greater than the minimum pressure required by the choke point to permit a transfer of fluid across it. The second chamber 106 can therefore always expel the fluid across the choke point 104 to the first chamber 102. The release pressure of the choke valve can be chosen depending upon the impact pressure that the energy absorbing device 100 is designed to take. Other components that can be used in lieu of the choke valve are a resistivity tube or a tube with a crimp in it. A crimped tube has a smaller diameter at the crimp than at any other parts of the tube.

The first chamber 102 and the second chamber 106 can be manufactured from any material that displays elasticity or ductility. In one embodiment, the first chamber 102 and the second chamber 106 may be manufactured from a polymer. The polymer is preferably in its elastic state at the temperature of operation of the energy absorbing device 100. The polymers are thermoplastic polymer, thermosetting polymers, or combinations thereof. Examples of thermoplastic polymers are polyethylene (PE), including high-density polyethylene (HDPE), linear low-density polyethylene (LLDPE), low-density polyethylene (LDPE), mid-density polyethylene (MDPE), glycidyl methacrylate modified polyethylene, maleic anhydride functionalized polyethylene, maleic anhydride functionalized elastomeric ethylene copolymers (like EXXELOR® VA1801 and VA1803 from ExxonMobil), ethylene-butene copolymers, ethylene-octene copolymers, ethylene-acrylate copolymers, such as ethylene-methyl acrylate, ethylene-ethyl acrylate, and ethylene butyl acrylate copolymers, glycidyl methacrylate functionalized ethylene-acrylate terpolymers, anhydride functionalized ethylene-acrylate polymers, anhydride functionalized ethylene-octene and anhydride functionalized ethylene-butene copolymers, polypropylene (PP), maleic anhydride functionalized polypropylene, glycidyl methacrylate modified polypropylene, polyacetals, (meth)acryl polymers (which as used herein includes polymers of acrylic acid, methacrylic acid, (C1-C6)alkyl acrylates, (C1-C6)alkyl methacrylates, and copolymers comprising a least one of the foregoing), polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, polyurethanes, or the like, or a combination comprising at least one of the foregoing thermoplastic polymers.

Thermosetting polymers may also be used. Examples of thermosetting polymers are epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, novolacs, resoles, melamine-formaldehyde polymers, urea-formaldehyde polymers, hydroxymethylfurans, isocyanates, diallyl phthalate, triallyl cyanurate, triallyl isocyanurate, unsaturated polyesterimides, or the like, or a combination comprising at least one of the foregoing thermosetting polymers.

In an exemplary embodiment, the first chamber 102 and the second chamber 106 may be manufactured from elastomers. The elastomer may be a thermoplastic polymer or a crosslinked polymer (i.e., a thermosetting polymer). The elastomers can be formed from saturated polymers, from unsaturated polymers, or from a combination of a saturated polymer and an unsaturated polymer. Examples of unsaturated polymers that can be cured into elastomers by sulfur vulcanization are natural polyisoprene (e.g., cis-1,4-polyisoprene natural rubber and trans-1,4-polyisoprene gutta-percha), synthetic polyisoprene; polybutadiene; chloroprene rubber, polychloroprene (e.g., NEOPRENE® and BAYPREN®), butyl rubber (e.g., copolymer of isobutylene and isoprene), halogenated butyl rubbers (e.g., chloro butyl rubber and bromo butyl rubber), styrene-butadiene rubber (e.g., copolymer of styrene and butadiene), nitrile rubber (copolymer of butadiene and acrylonitrile), hydrogenated nitrile rubbers (e.g., THERBAN® and ZETPOL®), or the like, or a combination comprising at least one of the foregoing unsaturated polymers.

Examples of saturated rubbers are EPM (ethylene propylene rubber, a copolymer of ethylene and propylene), EPDM rubber (ethylene propylene diene rubber, a terpolymer of ethylene, propylene and a diene-component), epichlorohydrin rubber, polyacrylic rubber, silicone rubber (e.g., polysiloxanes), fluorosilicone rubber, fluoroelastomers (e.g., VITON®, TECNOFLON®, FLUOREL®, AFLAS® and DAI-EL®), perfluoroelastomers (e.g., TECNOFLON® PFR, KALREZ®, CHEMRAZ®, PERLAST®) polyether block amides, chlorosulfonated polyethylene (e.g., HYPALON®), ethylene-vinyl acetate, or the like, or a combination comprising at least one of the foregoing. The elastomers and unsaturated rubbers may be used as foams as well.

The fluid 110 used in the energy absorbing device 100 can be a gas or a liquid. In an exemplary embodiment, the fluid is a liquid. Liquids may be Newtonian or non-Newtonian. The liquid may be a shear thinning or a shear thickening fluid. Gels can be used as the fluid 110. In an exemplary embodiment, the fluid is a Newtonian fluid. Water is an example of a Newtonian fluid.

While the FIGS. 1 and 2 show the energy absorbing device 100 having a single first chamber 102 and a single second chamber 106, it is envisioned that there can be multiple first chambers 102 that are in fluid communication with a single second chamber. A plurality of choke points 104 can be used between the multiple first chambers and the single second chamber. The choke points 104 can be used in series or in parallel.

In another embodiment, a single first chamber 102 can be in communication with a plurality of second chambers 106. Once again, a plurality of choke points 104 can be used between the first chamber 102 and the second chamber 106.

In yet another embodiment, a plurality of first chambers 102 (one or more of which are in fluid communication with one another) are in fluid communication with a plurality of second chambers 106 (one of more of which are in fluid communication with one another). One of more choke points 104 can be in fluid communication with the plurality of first chambers 102 and the plurality of second chambers 106.

The first chamber 102 and the second chamber 106 act cooperatively to absorb any impact that the device 100 is subjected to. In one embodiment, in one method of using the energy absorption device 100, when the device is subjected to an impact, a portion of the energy of the impact is absorbed by the first chamber 102 and is transferred to the fluid 110 and to the walls of the chamber 102. When the impact energy exceeds the pressure setting of the choke point 104, the excess energy of the impact is used in deforming the first chamber 102, which results in an expulsion of fluid from the first chamber 102 into the second chamber 106. The first chamber 102 attains a higher energy state as a result of the deformation. The second chamber 106 expands in size as it takes in the fluid that is expelled from the first chamber 102. The second chamber 106 is also now in a higher energy state as a result of its expansion. Since both the first chamber 102 and the second chamber 106 are in unfavorable energy states they both are primed to return to their original states. The first chamber 102 returns to its pre-deformed state while at the same time, the second chamber 106 forces the fluid 110 back into the first chamber 102 by virtue of its elasticity. In one embodiment, depending upon the position of the device 100, gravity may be used to assist the fluid in its return from the second chamber 106 to the first chamber 102. No other external manmade forces are used to assist the second chamber 106 in returning the fluid to the first chamber 102. The transferring of the fluid from the first chamber 102 to the second chamber 106 and vice versa permits the device to be reusable. This saves costs associated with maintenance and repair or replacement of other devices which undergo catastrophic damage as a result of similar impact.

In one embodiment, in one method of manufacturing the device 100, the first chamber is molded in a first operation, while the second chamber is molded in a second operation. A choke point is manufactured in a separate operation. The first chamber and the second chamber are then put in fluid communication with the choke point by being clamped or adhesively bonded to the choke point. The molding operation includes injection molding, blow molding, vacuum forming, or the like, or a combination comprising at least one of the foregoing operations. In one embodiment, the entire device can be manufactured in one integral unitary piece in a single molding operation.

The energy absorbing device can be used as bumpers in automobiles, stationary barriers that are used for stopping vehicles, crash helmets, shock absorbers, and the like.

In one embodiment, the energy absorbing device may be used in a crash helmet. The energy absorbing device may be disposed in series on strips in the helmet. A plurality of such strips can be used in the helmet. The strips can be permanently bonded (e.g., adhesively bonded or thermally fused) or fastened using a reversible bonding material (e.g., VELCRO®) to the inside of the helmet. In one embodiment, two or more energy absorbing devices can be disposed in opposing configurations to each other on a single strip. For example a first energy absorbing device having the first chamber and the second chamber can be positioned adjacent to a second energy absorbing device (also having the first chamber and the second chamber) such that the first chamber of the first energy absorbing device is adjacent to the second chamber of the second energy absorbing device and wherein the second chamber of the first energy absorbing device is adjacent to the first chamber of the second energy absorbing device. In other words, each energy absorbing device is opposedly disposed to with respect to its neighboring device. In one embodiment, each helmet contains at least one pair of devices opposedly disposed next to each other. As noted above, the energy absorbing devices contain at least one chamber that contains a Newtonian fluid. In one embodiment, the energy absorbing devices used in the fluid can also contain both Newtonian and non-Newtonian fluids if desired.

In one embodiment, two or more opposedly disposed energy absorbing devices may be disposed in a walled container. The wall may be manufactured from an elastomeric material that can itself absorb impact without being damaged beyond its elastic modulus. The walled container along with the energy absorbing devices may be disposed on the strip which is then bonded to the helmet. Alternatively, one or more individual walled containers may be disposed at selected positions inside the helmet.

In the helmet, the strips containing the energy absorbing devices of the FIG. 1 can be alternated with strips containing other energy absorbing devices that comprise only a single chamber, where the single chamber contains either a Newtonian or a non-Newtonian fluid. In another embodiment, the strips contained the walled containers can be alternated with strips containing the other energy absorbing devices that comprise only a single chamber, where the single chamber contains either a Newtonian or a non-Newtonian fluid.

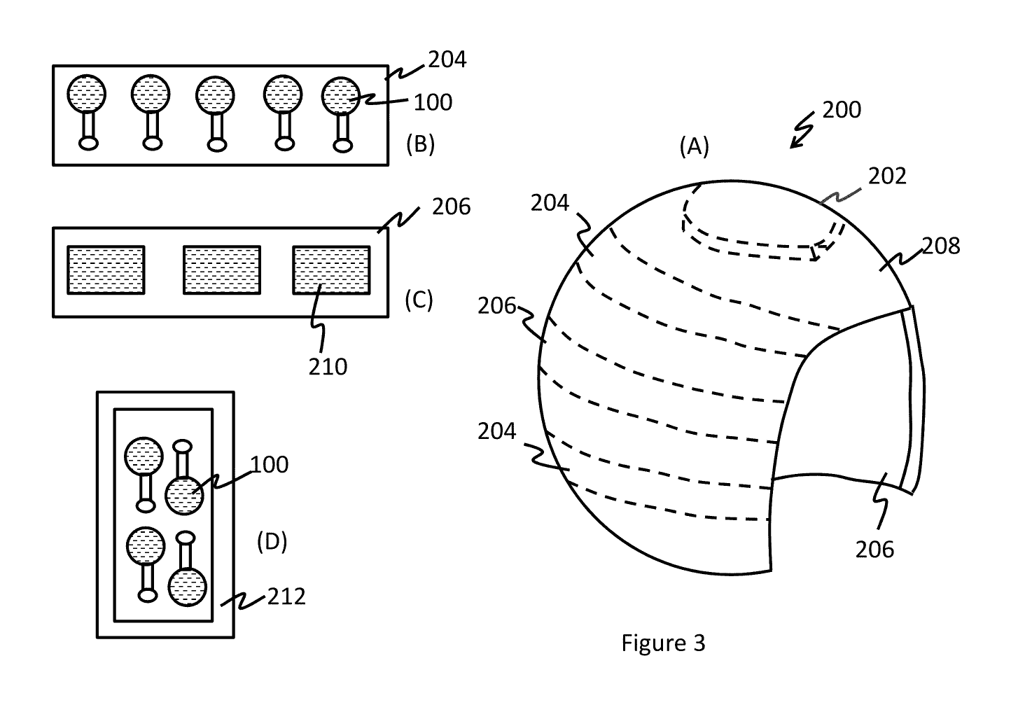

FIGS. 3(A)-3(D) depict examples of the use of the energy absorbing device 100 (from the FIGS. 1 and 2) in an article-namely a crash helmet 200. Strips 204 and 206 alternate with one another on the inside the helmet 200. In FIG. 3(A), the helmet is depicted as containing a pouch 202 that contains a Newtonian or a non-Newtonian fluid. In the FIG. 3(B), the strip 204 comprises a plurality of energy absorbing devices 100 disposed thereon, while strip 206 (see FIG. 3(C)) has the other energy absorbing devices 210 (e.g., pouches that can be filled with a Newtonian fluid, a non-Newtonian fluid, or a combination thereof). In an embodiment, the energy absorbing devices 210 contain a Newtonian fluid. The strips 204 and 206 are disposed on the inside of the helmet (i.e., the portion that contacts the head of a living being), the outside of the helmet, or between the outside surface of the helmet and an inside surface of the helmet 200. It can also be disposed on both the outside and the inside of the helmet 200.

FIG. 3(D) depicts the walled container 212 that surrounds a plurality of energy absorbing devices 100. The energy absorbing devices are disposed in opposing configurations next to each other. While the FIG. 3(D) depicts the opposing configurations as being horizontally separated, they can also be vertically separated, i.e., a first energy absorbing device can be in an opposed configuration to the second energy absorbing device, which is vertically separated from the first energy absorbing device.

The energy absorbing devices 100 of the FIG. 3(D) can be arranged in a 3-dimensional configuration i.e., there can be 2 or more energy absorbing devices arranged in a single horizontal plane or in a single vertical plane.

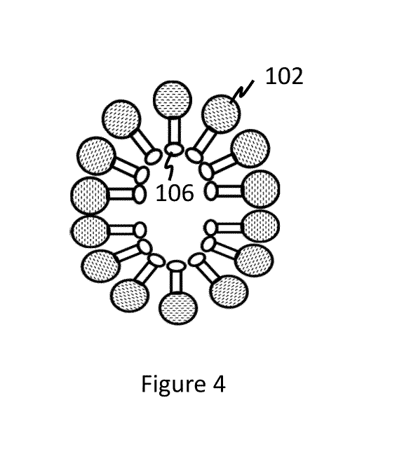

The FIG. 4 is a depiction of another exemplary configuration of energy absorbing devices. In this configuration, each energy absorbing device may be disposed such that the second chambers 106 of each device are opposedly disposed to at least one second chamber of another energy absorbing device and where the second chambers of each device lie on the circumference of a first circle or an ellipse. The first chamber 102 of each energy absorbing device are located on a second circle or ellipse that is larger in area than the first circle or ellipse. The geometry of the first circle or ellipse and of the second circle or ellipse may be changed to be squares, rectangles, triangles, polygons, or the like. The configuration of the FIG. 4 may be contained in a walled container.

The energy absorbing device and the articles that contain them are exemplified in the following example.

### EXAMPLE

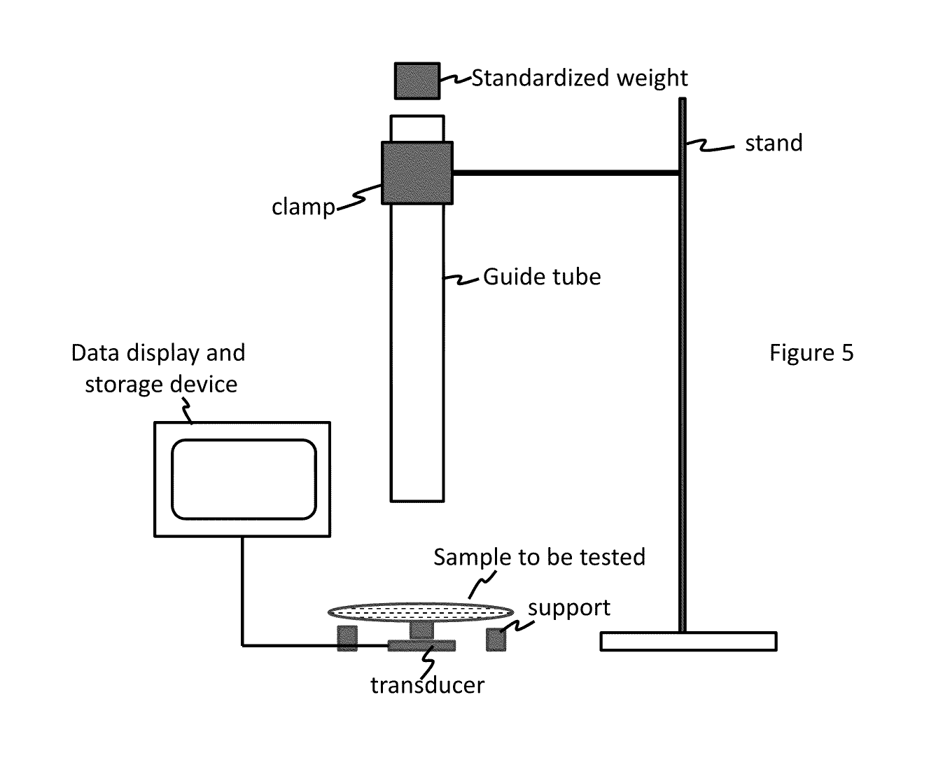

This example demonstrates the impact resistant capabilities of the energy absorbing device described herein. Several different energy absorbing materials including the energy absorbing device disclosed herein were tested on a device shown in the FIG. 5. The device comprises a stand that supports a guide tube. The guide tube guides a chosen weight dropped through it onto the energy absorbing material. The energy absorbing material rests upon a support. The side of the energy absorbing material that is opposed to the side that is impacted by the chosen weight contacts a pressure transducer. The pressure transducer measures the intensity of the impact (from the chosen weight) as well as the nature of its dissipation, which is then depicted on a display. The display device may be a computer or TV screen and the display device can contain a data storage system for acquiring and saving data.

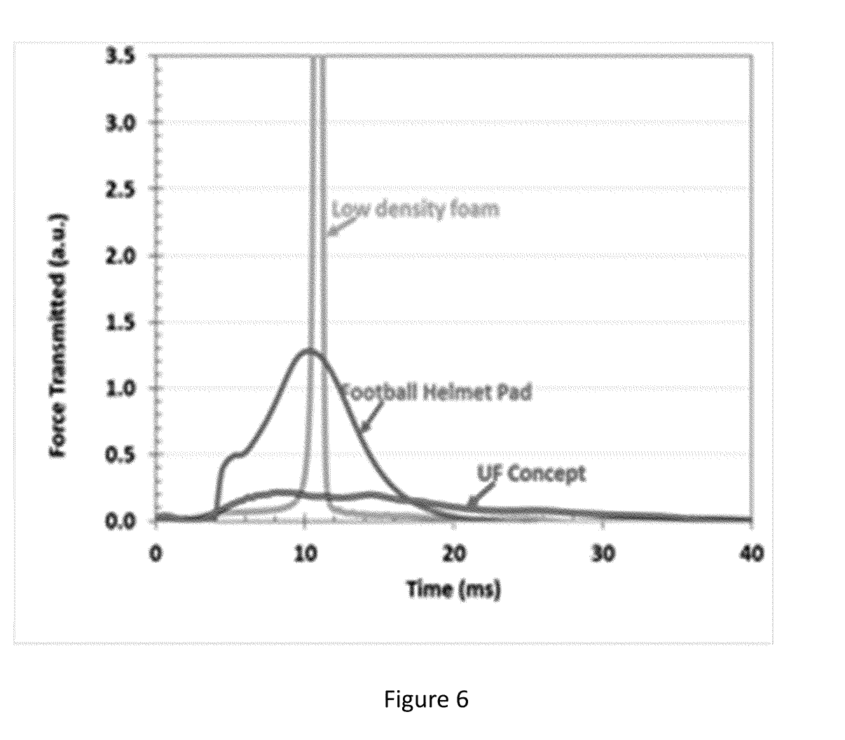

The materials tested in the energy absorbing device are a low density foam, a standard commercially available football helmet pad and the energy absorbing device of the FIG. 1. The first chamber of the energy absorbing device of FIG. 1 has a volume of approximately 50 to 100 milliliters and is filled with water. The chosen weight for the test was 500 grams dropped from a height of 1 foot through the guide tube. The results are shown in the FIG. 6.

The FIG. 6 shows that the low density foam does not dampen the impact from the weight. Most of the force is transmitted through this foam to the transducer. The standard football helmet pad dissipates the energy from the impact better than the low density foam, but still transfers a significant part of the impact to the transducer. The energy absorbing device disclosed herein shows a substantial reduction of the force transmitted to the transducer when compared with the low density foam and the standard football helmet pad. A significant portion of the impact is dissipated by the energy absorbing device. From this data it may be seen that the energy absorbing device disclosed herein is superior in its impact dissipation properties when compared with the standard football helmet pad.

The energy absorbing device disclosed herein is capable of absorbing more energy and in a more controlled and calibrated fashion (when compared with the other comparative materials) and thereby reduces direct and indirect trauma to the brain. The energy absorbing device provides better protection from both linear and rotational components of an impact force. These energy absorbing devices can be easily applied to an existing helmet and removed when not desired. They can therefore retroactively fitted onto existing helmets or other articles such as tanks, automobiles, barriers at checkpoints, and the like.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, singular forms like “a,” or “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

The term and/or is used herein to mean both “and” as well as “or”. For example, “A and/or B” is construed to mean A, B or A and B.

The transition term “comprising” is inclusive of the transition terms “consisting essentially of” and “consisting of” and can be interchanged for “comprising”.

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. An energy absorbing device comprising:
a first chamber; where the first chamber has a predetermined shape and contains a fluid that can be expelled upon the first chamber being subjected to an impact; and
a second chamber in fluid communication with the first chamber; the second chamber being operative to receive the fluid that is expelled from the first chamber and to return the fluid to the first chamber as a result of pressure generated by its own elasticity and without the assistance of any other external manmade force, where at least one of the first chamber or the second chamber contains a foam.

2. The energy absorbing device of claim 1, further comprising a choke point that is disposed between the first chamber and the second chamber; where the choke point is in fluid communication with the first chamber and the second chamber and where the choke point has a minimum pressure that is overcome in order to permit a transfer of fluid from the first chamber to the second chamber.

3. The energy absorbing device of claim 2, where the fluid is a Newtonian fluid, a non-Newtonian fluid, a gel or a combination thereof.

4. The energy absorbing device of claim 3, where the first chamber and the second chamber are in their lowest energy state prior to an impact that deforms the first chamber.

5. The energy absorbing device of claim 1, where the first chamber and the second chamber act cooperatively to absorb an impact.

6. The energy absorbing device of claim 1, where the first chamber and the second chamber are in an energy state that is higher than their respective lowest energy states after an impact and where both the first chamber and their second chamber return towards their lowest energy states on their own without any external assistance.

7. The energy absorbing device of claim 2, where the first chamber and the second chamber are disposed on opposing ends of the choke point.

8. The energy absorbing device of claim 1, where the first chamber and the second chamber comprise a polymer.

9. The energy absorbing device of claim 1, further comprising a plurality of first chambers that are in fluid communication with a single second chamber, a plurality of second chambers that are in fluid communication with a single first chamber or a plurality of first chambers that are in fluid communication with a plurality of second chambers.

10. The energy absorbing device of claim 2, further comprising a plurality of first chambers that are in fluid communication with a single second chamber, a plurality of second chambers that are in fluid communication with a single first chamber or a plurality of first chambers that are in fluid communication with a plurality of second chambers.

11. A method comprising:
subjecting an energy absorbing device to an impact, where the impact is sufficient to deform a first chamber and where the energy absorbing device comprises:
the first chamber; where the first chamber has a predetermined shape and contains a fluid that can be expelled upon the first chamber being subjected to the impact; and
a second chamber in fluid communication with the first chamber; the second chamber being operative to receive the fluid that is expelled from the first chamber and to return the fluid to the first chamber as a result of pressure generated by its own elasticity and without the assistance of any other external force, where at least one of the first chamber or the second chamber contains a foam.

12. The method of claim 11, where the first chamber and the second chamber both return to their original shape after the impact.

13. The method of claim 11, where the first chamber and the second chamber both return to their original shape after the impact without any external assistance.

14. A method comprising:
molding a first chamber;
molding a second chamber;
manufacturing a choke point; and
assembling the first chamber, the second chamber and the choke point in a manner such that the first chamber and the second chamber are disposed on opposing sides of the choke point.

15. The method of claim 14, where the molding comprises injection molding, vacuum forming, blow molding, compression molding, or a combination comprising at least one of the forgoing.

16. An energy absorbing article comprising:
a first energy absorbing device and a second energy absorbing device, where the first energy absorbing device and the second energy absorbing device each comprise:
a first chamber; where the first chamber has a predetermined shape and contains a fluid that can be expelled upon the first chamber being subjected to an impact; and
a second chamber in fluid communication with the first chamber; the second chamber being operative to receive the fluid that is expelled from the first chamber and to return the fluid to the first chamber as a result of pressure generated by its own elasticity and without the assistance of any other external manmade force; and where the first energy absorbing device is opposedly disposed to the second energy absorbing device such that the first chamber of the first energy absorbing device lies adjacent to the second chamber of the second energy absorbing device, and where the second chamber of the first energy absorbing device lies adjacent to the first chamber of the second energy absorbing device.

17. The energy absorbing article of claim 16, further comprising a walled container that surrounds the first energy absorbing device and the second energy absorbing device.

18. The energy absorbing article of claim 16, where the article is a helmet.

19. The helmet of claim 18, where the energy absorbing article is disposed on a first strip.

20. The helmet of claim 19, further comprising a second strip that alternates with the first strip, where the second strip comprises one or more pouches that contain a Newtonian fluid, a non-Newtonian fluid, a gel or a combination thereof.
